(19) United States
(12) Patent Application Publication
(10) Pub. No.: US 2009/0052709 A1
(43) Pub. Date: Feb. 26, 2009

(54) HEARING AID SLEEVE

(76) Inventor: Richard C. Smith, Costa Mesa, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/844,794

(22) Filed: Aug. 24, 2007

(51) Int. Cl. H04R 25/00

(52) U.S. Cl. 381/328

(57) ABSTRACT

Systems and methods are disclosed for enhancing the performance of hearing aids and the like. For example, a sleeve for a hearing aid can include a layer of resilient material that is configured to cover that portion of the hearing aid that is inserted into the ear canal. The sleeve cushions sensitive tissues of the ear canal from contact with the hard plastic housing of the hearing aid. The sleeve also inhibits undesirable leakage of sound around the hearing aid. Thus, both comfort and effectiveness of a hearing aid or the like are enhanced.

### TECHNICAL FIELD

The present invention relates generally to audiology. The present invention relates more particularly to a sleeve for hearing aids that makes them more comfortable to wear, as well as more effective.

### BACKGROUND

Hearing aids for enhancing the ability of the hearing impaired to hear are well known. Hearing aids have a microphone, an amplifier, a battery, and speaker. The microphone picks up ambient sound, such as voices. The amplifier increases the intensity of at least selected portions of the sound so that it can more easily be heard. The battery provides power to the amplifier. The speaker converts an electronic signal from the amplifier into sound at the user's ear.

Some hearing aids include a filter that tends to reject non-voice sounds. The use of a filter helps make voice more intelligible by at least partially eliminating sound that can interfere with voice so as to make it more difficult to hear and understand.

Some hearing aids are analog and some hearing aids are digital. Analog hearing aids use analog electronic circuitry to amplify and/or filter sound. Digital hearing aids use digital circuitry to amplify and/or filter sound. The use of digital circuitry can provide enhanced control over the hearing aid's ability to reject unwanted sounds.

Some hearing aids have the microphone, amplifier, battery, and filter located behind the ear and are therefore referred to as behind-the-ear (BTE) hearing aids. Such hearing aids also have a portion that is in the ear. The portion in the ear contains the speaker. The speaker can be located in the conchae or the ear canal.

Some hearing aids are disposed entirely within the ear and are known as in-the-ear (ITE) hearing aids. A portion of the hearing aid can be located within the conchae and another portion of the hearing aid can be located within the ear canal. Typically, the microphone, amplifier, battery, and filter of ITE hearing aids are located in the conchae and the speaker is located within the ear canal.

Some hearing aids are disposed entirely within the ear canal and are known as completely-in-the-canal (CIC) hearing aids. The microphone, amplifier, battery, speaker, and filter are all disposed in the ear canal of the user.

Generally, at least a portion of the speaker is disposed in the ear canal regardless of the type of hearing aid. The entire speaker and other components of the hearing aid can be disposed either completely or partially in the ear canal.

Although such contemporary hearing aids have proven generally suitable for their intended purposes, they possess inherent deficiencies which detract from their overall desirability and effectiveness. For example, the speaker and any other components that are to be disposed in the ear canal are commonly contained within a rigid plastic housing. The rigid plastic housing can press upon and/or abrade sensitive tissues of the ear canal. This can result in irritation and/or damage to these tissues.

Further, the rigid plastic housing does not typically seal well against the ear canal, thus allowing unfiltered ambient sound to reach the eardrum. The unfiltered ambient sound includes noise that would otherwise have been mitigated by the hearing aid's filter. This noise makes voice less intelligible and thereby adversely affects the effectiveness of the hearing aid.

Improper sealing of the hearing aid with respect to the ear canal can also allow amplified sound to escape from the ear canal and be picked up with the hearing aid's microphone. This can result in positive feedback that causes a squeal. The squeal can be very loud to the hearing aid wearer and is extremely annoying.

As such, although the prior art has recognized, to a limited extent, problems associated with the use of hearing aids, the proposed solutions have, to date, been ineffective in providing a satisfactory remedy. Therefore, it is desirable to provide an improvement to hearing aids and the like that enhances the comfort and effectiveness thereof.

### BRIEF SUMMARY

Systems and methods are disclosed herein to enhance the performance of hearing aids and the like. For example, in accordance with an embodiment a sleeve for a hearing aid or the like comprises a layer of resilient material configured to cover at least a portion of a hearing aid. The sleeve can cover that portion of the hearing aid that is configured to be inserted into a user's ear canal during use. The sleeve can cover all of the portion of the hearing aid that is configured to be inserted into the user's ear canal or can cover some of the portion of the hearing aid that is configured to be inserted into the user's ear canal.

More specifically, in accordance with an embodiment the sleeve can be formed of rubber. Various other bio-compatible materials can be used. The sleeve can have an opening in one end thereof though which the hearing aid or a portion thereof is inserted and can have an opening in another end thereof through which sound is transmitted to the eardrum. Optionally, one or more flanges can seal the ear canal so as to inhibit the transmission of ambient noise therethrough and can further cushion sensitive tissues of the ear canal. Optionally, foam can be formed upon the sleeve, such as upon the inner end thereof, so as to inhibit the transmission of ambient noise around the hearing aid and through the ear canal. The foam can further cushion sensitive tissues of the ear canal. Optionally, a diaphragm can seal the end of the sleeve though which sound is emitted.

According to an embodiment, a hearing aid or the like can be coated with a resilient material. This may be done, for example, by dipping a hearing aid housing at least partially into liquid rubber or the like and then allowing the liquid rubber to cure upon the hearing aid so as to form a coating thereon.

According to an embodiment, a hearing aid assembly can comprise a hearing aid having at least a portion that is configured to be disposed within a user's ear canal and a sleeve. The sleeve can comprise a layer of resilient material configured to cover at least a portion of a hearing aid.

According to an embodiment, a completely-in-the-canal (CIC) hearing aid assembly can comprise a completely-in-the-canal (CIC) hearing aid and a sleeve. The sleeve can comprise a layer of resilient material configured to cover at least a portion of a hearing aid that is configured to be inserted into a user's ear canal during use.

According to an embodiment, a sleeve for a hearing aid can comprise means for covering at least a portion of a hearing aid that is configured to be inserted into a user's ear canal, means for facilitating insertion of a hearing aid into the sleeve, and means for facilitating transmission of sound from the sleeve.

According to an embodiment, a method for making a sleeve for a hearing aid can comprise injection molding a resilient material so as to form a layer of resilient material that is configured to cover at least a portion of a hearing aid.

According to an embodiment, a method for using a hearing aid can comprise placing a sleeve over at least a portion of the hearing aid and placing the portion into the user's ear canal.

According to an embodiment, a sleeve for a wireless receiver or the like can comprise a layer of resilient material configured to cover at least a portion of the wireless receiver, wherein the portion of the wireless receiver is configured to be inserted into a user's ear canal during use.

Benefits include more comfortable use of hearing aids and the like. Comfort is enhanced because the resilient layer cushions sensitive tissue of the ear canal. Flanges, foam, and/or gel can further enhance comfort. Benefits also include more effective use of hearing aids as the like. The resilient layer, the flanges, foam, and/or gel better seal the ear canal so as to substantially inhibit the leakage of ambient noise around the hearing aid and into the ear, as well as to similarly substantially mitigate the leakage of amplified sound around the hearing aid and to the microphone thereof in a manner that cause squealing.

This invention will be more fully understood in conjunction with the following detailed description taken together with the following drawings.

### BRIEF DESCRIPTION OF THE DRAWINGS

FIG. 1 is a semi-schematic side view of a contemporary completely-in-the-ear (CIC) hearing aid;

FIG. 2 is a semi-schematic perspective view of the CIC hearing aid of FIG. 1;

FIG. 3 is a semi-schematic side view of a hearing aid sleeve with dashed lines indicating the hollow cavity within which a hearing aid can be disposed, according to an exemplary embodiment;

FIG. 4 is a semi-schematic perspective view of the sleeve of FIG. 3;

FIG. 5 is a semi-schematic side view of a hearing aid sleeve having one flange formed thereon, according to an exemplary embodiment;

FIG. 6 is a semi-schematic perspective view of the sleeve of FIG. 5;

FIG. 7 is a semi-schematic side view of a hearing aid sleeve having three flanges formed thereon, according to an exemplary embodiment;

FIG. 8 is a semi-schematic perspective view of the sleeve of FIG. 7;

FIG. 9 is a semi-schematic side view of the sleeve of FIGS. 7 and 8 having the CIC hearing aid of FIGS. 1 and 2 disposed therein;

FIG. 10 is a semi-schematic perspective view of the sleeve and CIC hearing aid of FIG. 9;

FIG. 11 is a semi-schematic side view of a sleeve having foam covered inner end, according to an exemplary embodiment; and

FIG. 12 is semi-schematic perspective view of the sleeve of FIG. 11.

Embodiments of the present invention and their advantages are best understood by referring to the detailed description that follows. It should be appreciated that like reference numerals are used to identify like elements illustrated in one or more of the figures.

### DETAILED DESCRIPTION

A method and system for enhancing the comfort and effectiveness of hearing aids, wireless receivers, music players, and the like are disclosed. According to one embodiment, a sleeve for a hearing aid comprises a layer of resilient material configured to cover at least a portion of a hearing aid.

The resilient material can comprise rubber, such as silicone rubber. Alternatively, the resilient material can comprise any other resilient biocompatible material. The resilient material can have a Shore A durometer of between approximately 35 and approximately 45. For example, the resilient material can have a Shore A durometer of approximately 40.

The resilient material can be a layer that generally defines a tapered, generally tubular, structure. The tapered structure can have a larger opening at one end thereof through which at least a portion of a hearing aid is inserted and can have a smaller opening at another end though which sound is transmitted. The tapered structure can be configured so as to generally conform to the shape of the ear canal so as to provide a snug fit.

One or more flanges can optionally be formed to the resilient material. For example, one, two, three, four, five, or more flanges can be formed to the resilient material. The flanges can be formed integrally with the resilient material and can thus be formed of the same material as the resilient material. Alternatively, the flanges can be formed non-integrally with the resilient material can be formed of a different material with respect thereto.

Optionally, foam can be formed upon the resilient material, such as upon an inner end thereof. Any desired combination of flanges and foam can be used. The flanges and foam both enhance comfort and effectiveness of the hearing aid. Comfort is enhanced by inhibiting contact of rigid parts of the hearing aid with sensitive tissues of the ear canal. Effectiveness is enhanced by mitigating leakage of sound around the hearing aid and through the ear canal.

Various embodiments of the sleeve can be used with a variety of different hearing devices such as hearing aids, earphones, and wireless receivers. For example, embodiments can be used with hearing aids such as behind-the-ear (BTE), in-the-ear (ITE), and completely-in-the-canal (CIC) hearing aids. Embodiments can be used with earphones for cellular telephones, as well as music players such as MP3 players and iPods. Embodiments can be used with wireless receivers such as those can be placed within the ear canal to facilitate the reception of covert communications. The term “hearing aid” can be used generically herein to refer to all such devices.

Optionally, a diaphragm can seal an inner end of the sleeve to prevent soiling of the hearing aid with earwax. The diaphragm can be formed of the same material as the sleeve. The diaphragm can be integrally formed with the sleeve. The diaphragm can be sufficient thin so as to readily facilitate the transmission of sound therethrough.

As mentioned above, the resilient material inhibits contact of the hearing aid with tissue of the ear canal. Thus, the resilient material covers those portions of the hearing aid that would otherwise contact tissue of the ear canal.

The resilient material can be flesh colored. The color of the resilient material can be matched to the particular color of the skin of the wearer.

The sleeve can be formed by dipping a hearing aid housing at least partially into liquid rubber or the like and then allowing the liquid rubber to cure upon the hearing aid housing so as to form a coating thereon. A sleeve formed in this manner can adhere securely to the hear aid and thus not generally be removable therefrom. Optionally, a release agent can be applied to the hearing aid housing such that the sleeve is removable from the hearing aid. A mold can be used instead of the hearing aid housing itself. Thus, a mold, with or without a release agent, can be dipped into liquid rubber or the like to form the sleeve.

The sleeve can be formed by heat shrinking material onto the hearing aid or a mold. For example, heat shrink tubing can be shrunk onto a hearing aid to form the sleeve.

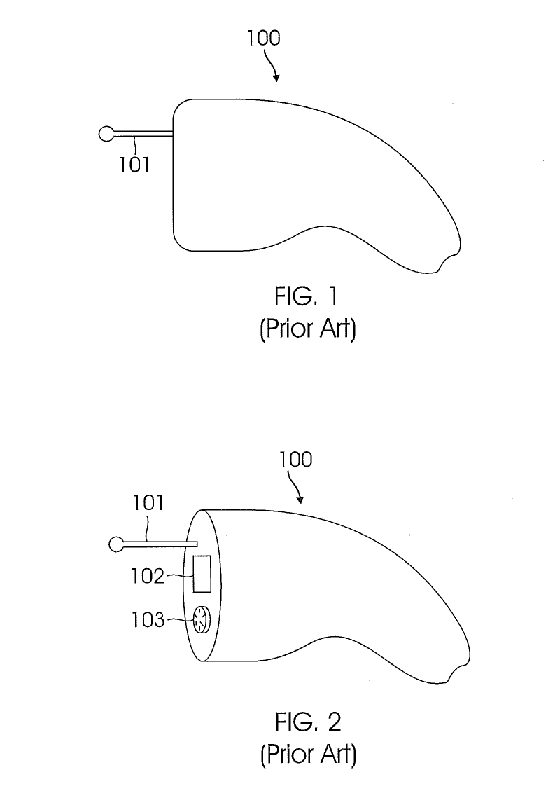

Referring now to FIGS. 1 and 2, a contemporary completely-in-the-ear (CIC) hearing aid 100 is configured to fit within the ear canal of a user. Such CIC hearing aids are generally curved so as to better conform to the shape of the ear canal.

Contemporary CIC hearing aids typically comprise a stem 101 that extends away from the outer end thereof so as to facilitate insertion of the hearing aid 100 into and removal of the hearing aid 100 from the user's ear canal. The user can grasp the stem 101 between the forefinger and thumb for facilitate insertion and removal from the ear canal.

Contemporary CIC hearing aids also typically comprise a battery compartment 102 within which a replaceable/rechargeable battery is disposed. They also typically comprise a volume control 103 that facilitates adjustment to the volume of the hearing aid 100.

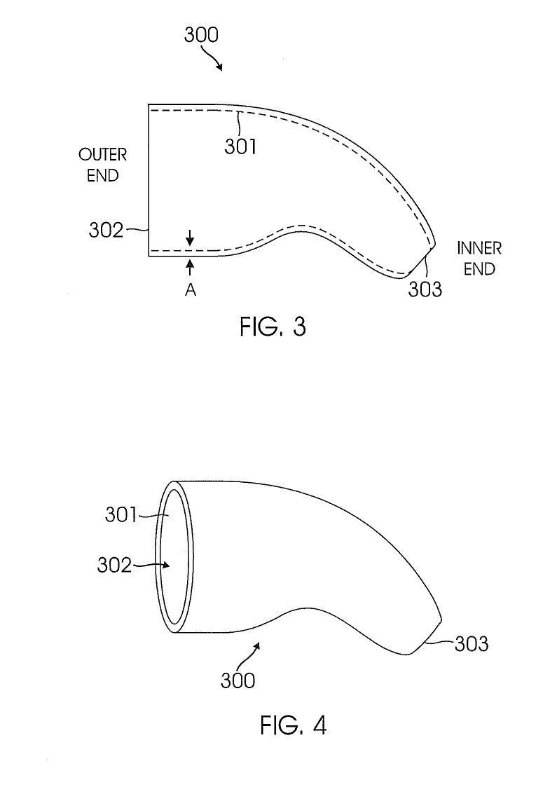

Referring now to FIGS. 3 and 4, a covering or sleeve 300 can be configured so as to substantially cover a hearing aid, such as the CIC hearing aid 100 of FIGS. 1 and 2. The sleeve 300 can cover at least that portion of the hearing aid that would otherwise contact the ear canal. In this manner, a softer, more cushioned surface is provided so as to enhance comfort and mitigate irritation to sensitive tissues of the ear canal.

The sleeve 300 can comprise a bore or cavity 301 that extends at least partially therethrough. The cavity 301 can extend completely through the sleeve 300, so as to define an outer opening 302 and an inner opening 303.

The sleeve 300 can have a thickness, dimension A, of between approximately 0.001 inch and approximately 0.100 inch. For example, the sleeve 300 can have a thickness of approximately 0.050 inch. The sleeve 300 can have a thickness greater than 0.100 inch. For example, greater thicknesses of sleeve 300 can be use to adapt smaller hearing aids to larger, e.g., greater diameter, ear canals and/or to provide a better or custom fit. Thinner thickness of sleeve 300 can be used when larger hearing aids are used in smaller ear canals.

Thinner thickness of sleeve 300 can be used to isolate the material of the hearing aid from the ear canal such as when the user has an allergy or sensitivity to the material of the hearing aid. For example, a sleeve having a thickness of approximately 0.001 inch can prevent contact of the hearing aid with the ear and thus can be used to mitigate the undesirable effects of an allergy or sensitivity of the wearer to the material of which the housing of the hearing aid is made.

The length, diameter, and shape of the sleeve 300 can conform generally to the length, diameter, and shape of the hearing aid. The inner diameter of the sleeve can be slightly less than the outer diameter of the hearing aid so as to provide a secure stretch fit.

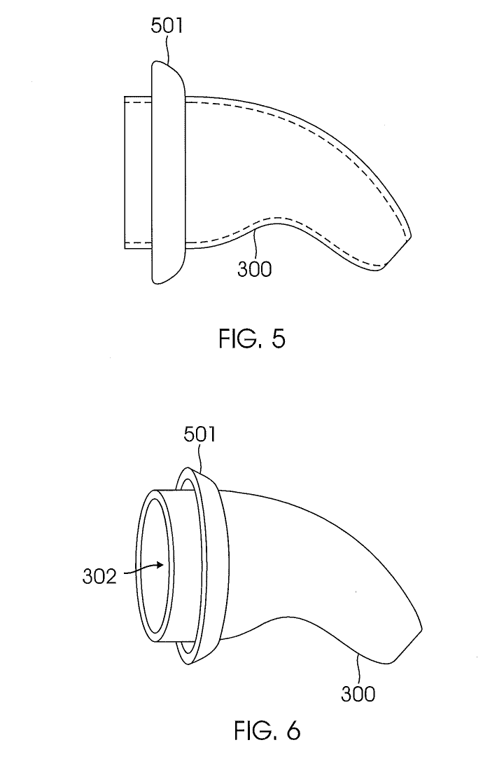

Referring now to FIGS. 5 and 6, one or more flanges, such as flange 501, can be formed upon sleeve 300. The flange(s) can be formed anywhere along the length of the sleeve 300. For example, a single flange 501 can be formed proximate the outer end as shown in FIGS. 5 and 6.

The flanges can be circular, oval, ellipsoidal, or of any other desired shape. The flanges can be shaped so as to generally conform to the shape of the ear canal at the position of the flanges when the hearing aid is inserted into the ear canal.

The flanges can be formed concentrically or eccentrically with respect to the sleeve 300. The flanges can thus be formed in a manner that enhances the comfort and sealing provided thereby.

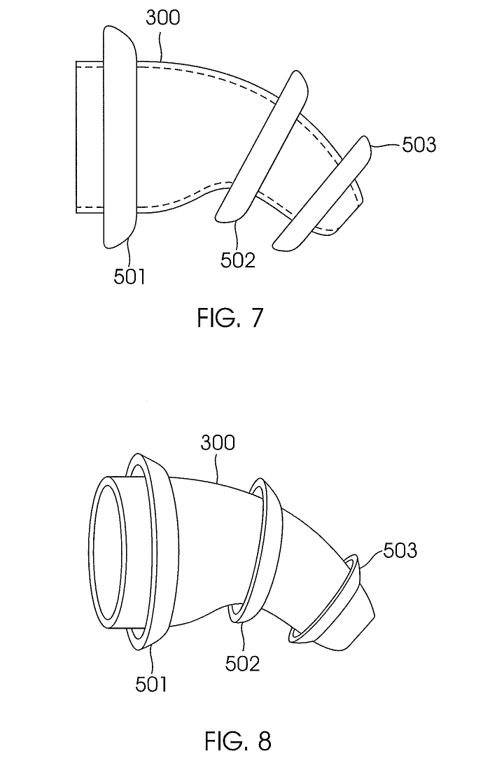

Referring now to FIGS. 7 and 8, any desired number of flanges can be provided. For example, one, two, three, four, or five flanges can be formed to sleeve 300. Thus, three flanges 501, 502, and 503 can be provided as shown in FIGS. 7 and 8.

The flange(s) can enhance sealing of the sleeve 300, and consequently of the hearing aid, with respect to the ear canal. Such sealing enhances the ability of the sleeve to inhibit the transmission of ambient sound around the hearing aid and through the ear canal to the eardrum. Such sealing also enhances the ability of the sleeve to inhibit the transmission of amplified sound around the hearing aid and through the ear canal to the hearing aid's microphone. Both of such transmissions are undesirable, as discussed herein.

The flange(s) can also enhance comfort by providing a soft, resilient surface for contact with sensitive tissues of the ear canal. For example, the hearing aid can be substantially undersized with respect to the ear canal and the flange(s) can fill in the additional space thus created between the hearing aid the ear canal. Thus, use of the flange(s) allows one size of hearing aid to fit a larger range of sizes of ear canals.

Foam or gel can be disposed proximate the flanges, such as therebeneath. A rubber skin or the like can cover the foam or gel. Such foam or gel can provide additional structural support to the flanges and can enhance the sealing provided thereby.

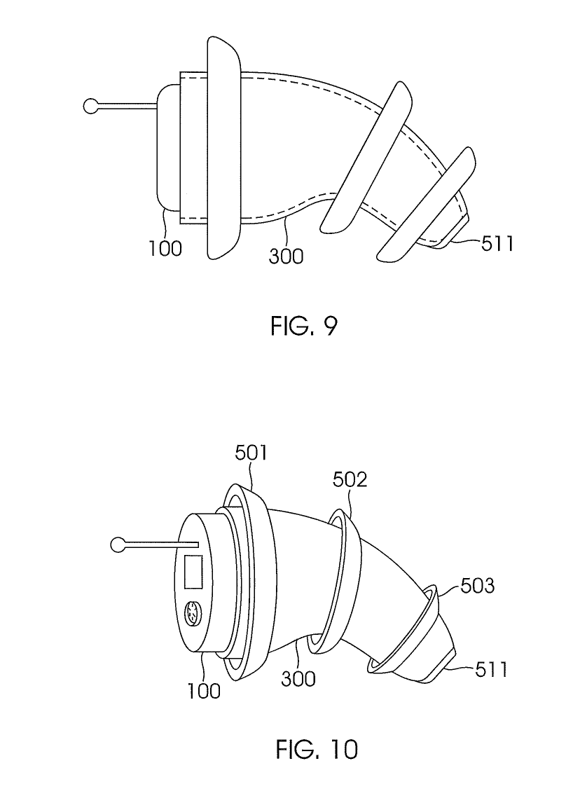

Referring now to FIGS. 9 and 10, the hearing aid 100 of FIGS. 1 and 2 is shown inserted into the sleeve 300 of FIGS. 7 and 8. The sleeve 300 can fit tightly over the hearing aid 100. The sleeve 300 can be sized such that it must be stretched in order to fit over the hearing aid 100.

Optionally, a diaphragm 511 can be formed at the inner end of sleeve 300. The diaphragm 511 can either completely cover or partially cover the inner opening 303 in the sleeve 300. The diaphragm 511 can inhibit undesirable soiling of the hearing aid 100, such as with earwax.

The covering provided by the sleeve 300, particularly if a diaphragm 511 is included, can substantially enhance hygiene and ease of maintenance associated with the use of a hearing aid. Hygiene and ease of maintenance are enhanced because it is the sleeve 300, rather than the hearing aid 100 that becomes soiled during use. As those skilled in the art will appreciate, hearing aids are comparatively difficult to clean thoroughly. They cannot simply be cleaned with soap and water. They cannot be immersed in water. Care must be taken to prevent water from entering a hear aid. Generally, if water enters a hearing aid, it may be damaged.

By way of contrast, a soiled sleeve 300 can be removed from the hearing aid and then simply be cleaned with soap and water. A sleeve 300 can be immersed in water without fear of damage. Thus, the use of a sleeve allows the hearing aid 100 to remain comparatively clean while also allowing the soiled covering to be easily cleaned.

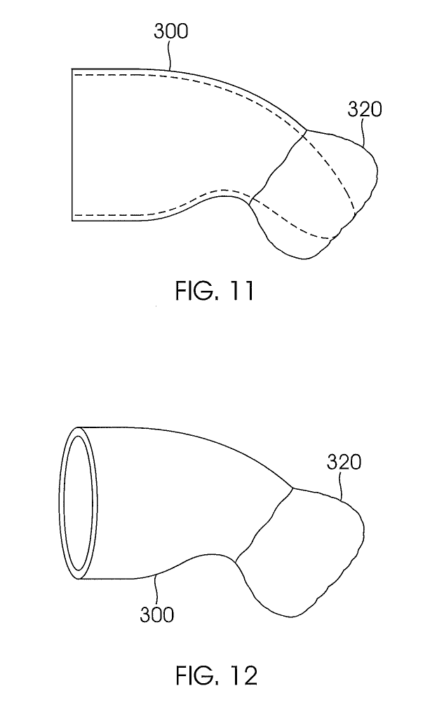

Referring now to FIGS. 11 and 12, a foam tip 320 can optionally be formed upon the inner end of sleeve 300. The foam tip 320 can be formed by stirring air into liquid rubber so as to aerate the liquid rubber. The inner end of sleeve 300 can then be dipped into the aerated liquid rubber to form the foam tip 300.

Foam tip 320 can be formed of the same material as sleeve 300. Foam tip 320 can be formed of any desired material. Either open cell or closed cell foam can be used.

The foam tip 320 can provide enhanced sealing of the sleeve 300, and consequently of the hearing aid 100 as well, with respect to the ear canal. Such enhanced sealing can better mitigate the transmission of unprocessed (unfiltered) ambient sound through the ear canal. As those skilled in the art will appreciate, the transmission of unprocessed sound through the ear canal when a hearing aid is worn can undesirably mitigate a user's ability to recognize sounds and understand speech.

The enhanced sealing provided by the foam tip 320 can also mitigate the transmission of amplified sound through the ear canal in a manner that causes positive feedback though the amplifier of the hearing aid. Such positive feedback results in undesirable squealing, as discussed herein.

The foam tip 320 can also enhance the comfort of wearing the hearing aid 100 by providing additional cushion between the hearing aid 100 and sensitive tissues of the ear canal. The foam tip 320 can prevent scraping of the inner end of the hearing aid 100 and/or the sleeve 300 against sensitive tissues of the ear canal when the hearing aid 100 is inserted into and removed from the ear canal.

Such foam can be applied anywhere along the length of the sleeve 300. For example, the foam can be applied at the locations of the flanges shown in FIG. 7 or can be applied substantially along the entire length of the sleeve 300. Any desired combination of flanges and foam can be used. Foam can be applied to the flanges.

Embodiments of the present invention can be used with various types of hearing aids and the like, including behind-the-hear (BTE), in-the-ear (ITE), and completely-in-the-canal (CIC) hearing aids. The hearing aids can be any hearing aids wherein at least a portion thereof is disposed within the ear canal. Embodiments can also be used with wireless receivers such as those worn in the ear canal by covert operatives. Wireless receivers are substantially similar to CIC hearing aids in appearance. The CIC hearing aids of FIGS. 1 and 2 can also be considered to be wireless receivers.

Embodiments can also be used with small speakers, such as those of music players, e.g., iPods and MP3 players. Such speakers can be located outside of the ear canal (such as in the conchae), partially within the ear canal, or entirely within the ear canal. Embodiments can be used with any devices that fit at least partially within the ear, particularly the ear canal.

One or more embodiments provide more comfortable use of hearing aids and the like. Comfort is enhanced because the resilient layer cushions sensitive tissue of the ear canal. Flanges and/or foam can further enhance comfort. In this manner, pressure and abrasion of the sensitive tissue is mitigated so as to likewise mitigate the occurrence of irritation and damage to the ear canal.

One or more embodiments enhance the effectiveness of hearing aids and the like by mitigating the leakage of undesirable sound into the ear. The resilient layer, the flanges, and/or foam better seal the ear canal so as to substantially inhibit the leakage of ambient noise around the hearing aid and into the ear canal such the likelihood of ambient noise interfering with speech is substantially inhibited. Thus, speech is more intelligible.

One or more embodiments enhance the effectiveness of hearing aids by mitigating the leakage of amplified sound out the ear. Thus, the amplified sound is inhibited from reaching the hearing aid's microphone where is can be picked up and re-amplified in a manner that results in the generation of an annoying squeal.

One or more embodiments can inhibit soiling of the hearing aid by proving an effective covering therefor. Thus, maintenance of the hearing aid is simplified and hygiene is improved. Maintenance is simplified by providing a covering that is soiled instead of the hearing aid itself being soiled. The covering is easily cleaned. Because the covering is easily cleaned, it is like to be cleaned better and more frequently, thus enhancing hygiene.

One or more embodiments facilitate the use of a given, e.g., smaller size, hearing aid with a larger range of ear sizes by functioning as an adapter between the hearing aid and the ear canal. Embodiments with or without flanges can be configured to make the shape and size of a hearing aid conform to the shape and size of the ear canal. By allowing a given size of hearing aid to fit a larger range of ear sizes, fewer sizes of hearing aids need to be stocked. By enhancing the fit of the hearing aid, the sleeve can facilitate more secure positioning of the hearing aid within the ear canal and can thus reduce the likelihood of loss of the hearing aid.

Embodiments described above illustrate, but do not limit, the invention. It should also be understood that numerous modifications and variations are possible in accordance with the principles of the present invention. Accordingly, the scope of the invention is defined only by the following claims.

1. A sleeve for a hearing aid, the sleeve comprising:
a layer of resilient material configured to cover at least a portion of a hearing aid; and
wherein the portion of the hearing aid is configured to be inserted into a user's ear canal during use.

2. The sleeve as recited in claim 1, wherein the resilient material comprises rubber.

3. The sleeve as recited in claim 1, wherein the resilient material comprises silicone rubber.

4. The sleeve as recited in claim 1, wherein the resilient material has a Shore A durometer of between approximately 35 and approximately 45.

5. The sleeve as recited in claim 1, wherein the resilient material has a Shore A durometer of approximately 40.

6. The sleeve as recited in claim 1, wherein the resilient material defines a tapered structure.

7. The sleeve as recited in claim 1, wherein the resilient material defines a tapered, generally tubular, structure having an opening in each end.

8. The sleeve as recited in claim 1, wherein the resilient material defines a tapered structure having a larger opening at one end thereof through which at least a portion of a hearing aid is inserted and having a smaller opening at another end though which sound is emitted.

9. The sleeve as recited in claim 1, further comprising at least one flange formed to the resilient material.

10. The sleeve as recited in claim 1, further comprising at least one flange formed integrally with the resilient material.

11. The sleeve as recited in claim 1, further comprising a plurality of flanges formed to the resilient material.

12. The sleeve as recited in claim 1, further comprising foam formed upon the layer of resilient material such that the foam provides enhanced cushioning or sealing of the ear canal.

13. The sleeve as recited in claim 1, further comprising foam formed upon an inner end of the layer of resilient material such that the foam provides enhanced cushioning or sealing of the ear canal.

14. The sleeve as recited in claim 1, wherein the resilient material is configured to at least partially cover a completely-in-the-ear (CIC) hearing aid.

15. The sleeve as recited in claim 1, further comprising a diaphragm sealing an inner end thereof.

16. The sleeve as recited in claim 1, wherein the resilient material inhibits contact of the hearing aid with tissue of the ear canal.

17. The sleeve as recited in claim 1, wherein the resilient material covers all of the hearing aid that would otherwise contact tissue of the ear canal.

18. The sleeve as recited in claim 1, wherein the resilient material has a thickness of between approximately 0.001 inch and approximately 0.100 inch.

19. The sleeve as recited in claim 1, wherein the resilient material has a thickness of approximately 0.050 inch.

20. The sleeve as recited in claim 1, wherein the resilient material is curved so as to generally conform to a curvature of the ear canal.

21. The sleeve as recited in claim 1, wherein the resilient material is flesh colored.

22. A hearing aid assembly comprising:
a hearing aid having at least a portion that is configured to be disposed within a user's ear canal; and
a sleeve comprising a layer of resilient material configured to cover at least a portion of the hearing aid.

23. A completely-in-the-canal (CIC) hearing aid assembly comprising:
a completely-in-the-canal (CIC) hearing aid;
a sleeve comprising:
a layer of resilient material configured to cover at least a portion of the hearing aid; and
wherein the portion of the hearing aid is configured to be inserted into a user's ear canal during use.

24. A sleeve for a hearing aid, the sleeve comprising:
means for covering at least a portion of a hearing aid, wherein the portion is configured to be inserted into a user's ear canal;
means for facilitating insertion of a hearing aid into the sleeve; and
means for facilitating transmission of sound from the sleeve.

25. A method for making a sleeve for a hearing aid, the method comprising:
injection molding a resilient material so as to form a layer of resilient material that is configured to cover at least a portion of a hearing aid; and
wherein the portion of the hearing aid is configured to be inserted into a user's ear canal during use.

26. A method for using a hearing aid, the method comprising:
placing a sleeve over at least a portion of the hearing aid, wherein the portion is configured to be placed within a user's ear canal; and
placing the portion into the user's ear canal.

27. A sleeve for a wireless receiver, the sleeve comprising:
a layer of resilient material configured to cover at least a portion of the wireless receiver; and
wherein the portion of the wireless receiver is configured to be inserted into a user's ear canal during use.

28. A method for making a hearing aid assembly, the method comprising:
dipping a hearing aid housing or a mold having a shape like a hearing aid housing at least partially into liquid rubber or the like and then allowing the liquid rubber to cure upon the hearing aid housing or the mold so as to form a coating thereon.
